(19) United States
(12) Patent Application Publication
(10) Pub. No.: US 2014/0148986 A1
(43) Pub. Date: May 29, 2014

(54) CONTROL SYSTEM AND CONTROL METHOD FOR HYBRID VEHICLE

(71) Applicants: Masato YOSHIKAWA, Susono-shi (JP); Shintaro MATSUTANI, Toyota-shi (JP)

(72) Inventors: Masato YOSHIKAWA, Susono-shi (JP); Shintaro MATSUTANI, Toyota-shi (JP)

(73) Assignee: TOYOTA JIDOSHA KABUSHIKI KAISHA, Toyota-shi (JP)

(21) Appl. No.: 14/087,164

(22) Filed: Nov. 22, 2013

(30) Foreign Application Priority Data
Nov. 27, 2012 (JP) 2012-258843

(51) Int. Cl. B60W 20/00; B60W 10/08; B60W 10/06

(52) U.S. Cl. CPC B60W 20/10; B60W 10/06; B60W 10/08; Y10S 903/93
USPC 701/22; 903/930

(57) ABSTRACT

A control system for a hybrid vehicle includes an engine and a motor as driving sources, and a controller. The controller reduces at least one of the engine driving force and the motor driving force in response to a request for deceleration of the vehicle, such that the proportion of the amount of reduction of the engine driving force and the amount of reduction of the motor driving force is changed, according to a request for re-acceleration of the vehicle.

### INCORPORATION BY REFERENCE

The disclosure of Japanese Patent Application No. 2012-258843 filed on Nov. 27, 2012 including the specification, drawings and abstract is incorporated herein by reference in its entirety.

### BACKGROUND OF THE INVENTION

1. Field of the Invention

The invention relates to control system and control method for a hybrid vehicle, and particularly relates to distribution of driving force between an engine and an electric motor during deceleration of the vehicle.

2. Description of Related Art

A hybrid vehicle that runs using an engine and an electric motor as driving sources is well known. Some technologies for optimally setting the distribution (proportion) of the driving force of the engine and the driving force of the motor, relative to the required driving force of the vehicle, in the hybrid vehicle, are disclosed. For example, Japanese Patent Application Publication No. 2011-63089 (JP 2011-63089 A) discloses a technology of restricting increase of engine torque so that the rate of increase of the engine torque becomes smaller than the rate of increase of required torque when required torque is rapidly increased, such as when the accelerator pedal is rapidly depressed, and controlling the driving force distribution so that motor torque compensates for a difference between the required torque and the engine torque.

### SUMMARY OF THE INVENTION

When the accelerator pedal is depressed, for example, to make a request for re-acceleration while the vehicle is being decelerated, it is desirable to quickly re-accelerate the vehicle. Meanwhile, the response of engine driving force (engine torque) when a request for re-acceleration is issued is poorer or worse than the response of motor driving force (motor torque). Here, the required driving force (required torque) of the vehicle is reduced during deceleration of the vehicle. When the driving force of the vehicle is reduced, the engine driving force is reduced so that the proportion of the motor driving force is increased, for example. Then, when a request for increase of the driving force of the vehicle is issued, the increase of the driving force is supposed to be mainly covered by the engine driving force since an allowable amount of increase of the engine driving force (torque) is larger than that of the motor driving force (torque). However, if the increase of the driving force is covered by the engine driving force, the response with which the vehicle is re-accelerated may deteriorate. In particular, in the operating state in which the output of the motor is limited, most of the increase of the driving force is covered by the engine driving force, which may result in deterioration of the response at the time of re-acceleration. On the other hand, if the driving force of the motor that is more advantageous in response than the engine is reduced in advance during deceleration of the vehicle, so that the driving force can be quickly generated when a request for increase of the driving force is issued, the response to re-acceleration is less likely or unlikely to deteriorate. However, the engine driving force is increased by an amount col to the reduction of the proportion of the motor driving force, resulting in deterioration of the fuel economy.

The invention provides control system and control method for a hybrid vehicle that runs using an engine and a motor as driving sources, which assure improved response when the vehicle that has been decelerated is re-accelerated, while improving the fuel economy during deceleration of the vehicle.

A control system for a hybrid vehicle according to a first aspect of the invention includes an engine that is a driving source of the vehicle, a motor that is a driving source of the vehicle, and a controller configured to distribute required driving force of the vehicle into engine driving force and motor driving force. The controller is configured to reduce at least one of the engine driving force and the motor driving force in response to a request for deceleration of the vehicle, such that a proportion of an amount of reduction of the engine driving force and an amount of reduction of the motor driving force is changed, according to a request for re-acceleration of the vehicle.

A control method for a hybrid vehicle having an engine and a motor as driving sources includes the steps of: distributing required driving force of the vehicle into engine driving force and motor driving force, so as to run the vehicle with the engine driving force and the motor driving force, and reducing at least one of the engine driving force and the motor driving force in response to a request for deceleration of the vehicle, such that a proportion of an amount of reduction of the engine driving force and an amount of reduction of the motor driving force is changed, according to a request for re-acceleration of the vehicle.

With the above arrangement, re-acceleration of the vehicle is determined in advance, and the proportion of reduction of engine driving force and that of motor driving force during deceleration of the vehicle is appropriately changed, so that the fuel economy during deceleration is improved, and the vehicle that has been decelerated is re-accelerated with high response.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view illustrating the general construction of a power transmission path between an engine and an electric motor, and drive wheels, which constitute a hybrid vehicle to which the invention is preferably applied, and is also a view illustrating principal portions of a control system provided in the vehicle for output control of the engine that functions as a source of driving force for running the vehicle, shift control of an automatic transmission, drive control of the motor, and so forth;

FIG. 2 is a functional block diagram useful for explaining principal control functions performed by an electronic control unit of FIG. 1;

FIG. 3 is a graph indicating changes in engine torque and motor torque when a request for deceleration is issued, which changes are effected by a first driving force distribution determining unit of FIG. 2;

FIG. 4 is a graph indicating changes in engine torque and motor torque when a request for deceleration is issued, which changes are effected by a second driving force distribution determining unit of FIG. 2;

FIG. 5 is a flowchart illustrating principal control operations of the electronic control unit of FIG. 1, namely, control operations for assuring high response when the vehicle that has been decelerated is re-accelerated, while improving the fuel economy during deceleration;

FIG. 6 is a time chart showing operating conditions based on the flowchart of FIG. 5;

FIG. 7 is another time chart showing operating conditions based on the flowchart of FIG. 5;

FIG. 8 is a view showing an allowable amount of increase of the engine driving force and that of the motor driving force set during deceleration of the vehicle; and

FIG. 9 is a flowchart illustrating principal control operations of an electronic control unit according to another embodiment of the invention, namely, control operations for assuring high response when the vehicle that has been decelerated is re-accelerated, while improving the fuel economy during deceleration.

### DETAILED DESCRIPTION OF EMBODIMENTS

One embodiment of the invention will be described in detail with reference to the drawings. In the drawings, the construction or arrangement of the embodiment is simplified or modified as needed, and the dimensional ratios and shapes of its components, elements or portions are not necessarily depicted correctly.

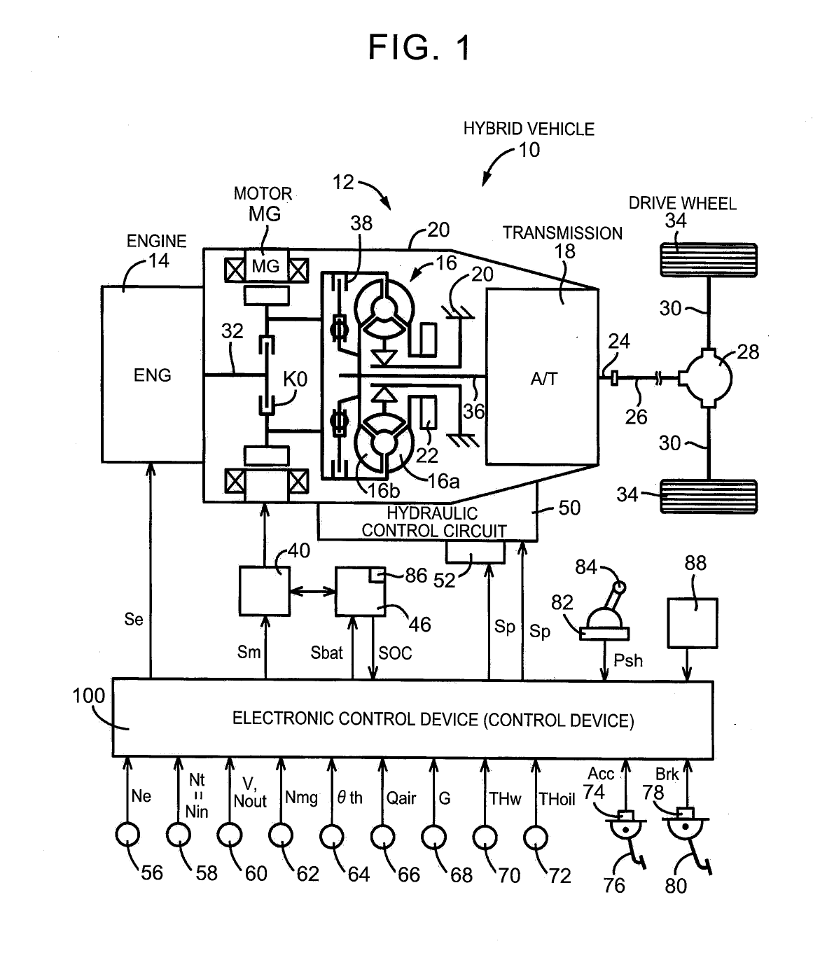

FIG. 1 illustrates the general construction of a power transmission path from an engine 14 and an electric motor MG to drive wheels 34, which constitute a hybrid vehicle 10 (which will be simply called “vehicle 10”) to which the invention is preferably applied. FIG. 1 also illustrates principal portions of a control system provided in the vehicle 10 for performing output control of the engine 14 that functions as a source of driving force for running the vehicle, shift control of an automatic transmission 18, drive control of the motor MG, and so forth.

In FIG. 1, a vehicular drive-train 12 (which will be simply called “drive-train 12”) includes an engine coupling/decoupling clutch K0 (which will be simply called “clutch K0”), motor MG, torque converter 16, oil pump 22, automatic transmission 18, and so forth, which are arranged in this order as viewed from the engine 14 side, and are placed in a transmission case 20 (Which will be simply called “case 20”) as a non-rotatable member attached to the vehicle body via bolts, or the like. The drive-train 12 also includes a propeller shaft 26 coupled to an output shaft 24 as an output rotary member of the automatic transmission 18, a differential gear device (differential gears) 28 coupled to the propeller shaft 26, a pair of axles 30 coupled to the differential gear device 28, and so forth. The drive-train 12 thus constructed is favorably used in a FR (front-engine, rear-drive) vehicle 10, for example. In the drive-train 12, when the clutch K0 is engaged, the power of the engine 14 is transmitted from an engine coupling shaft 32 that couples the engine 14 with the clutch K0 to a pair of drive wheels 34, via the clutch K0, torque converter 16, automatic transmission 18, propeller shaft 26, differential gear device 28, and the pair of axles 30, which are arranged in this order.

The torque converter 16 is a fluid transmission device that includes a pump impeller 16a as an input-side rotary element capable of rotating about its axis, a turbine wheel 16b as an output-side rotary element, and a lock-up clutch 38, and is operable to transmit driving force received by the pump impeller 16a to the automatic transmission 18 via fluid. The pump impeller 16a is connected to the engine 14 via the clutch K0 and the engine coupling shaft 32, and receives driving force from the engine 14. The turbine wheel 16b is coupled, e.g., splined to a transmission input shaft 36 as an input rotary member of the automatic transmission 18 such that the turbine wheel 16b and the input shaft 36 cannot rotate relative to each other. The lock-up clutch 38 is a direct-coupling clutch provided between the pump impeller 16a and the turbine wheel 16b, and is selectively placed in an engaged state, slipping state, or a released state, under hydraulic control, for example.

The motor MG is a so-called motor-generator that functions as a generator that generates mechanical driving force from electric energy, and also functions as a generator that generates electric energy from mechanical energy. In other words, the motor MG can function as a driving power source that generates driving force for running the vehicle, in place of the engine 14 as a driving power source, or together with the engine 14. Also, the motor MG generates electric energy from the driving force generated by the engine 14, or driven force (mechanical energy) received from the drive wheels 34 by regenerative braking, and stores the electric energy in a battery 46 as a power storage device, via an inverter 40 and a boost converter (not shown), for example. The motor MG is operatively coupled to the pump impeller 16a, and power is transmitted between the motor MG and the pump impeller 16a. Accordingly, like the engine 14, the motor MG is connected to the transmission input shaft 36 such that power can be transmitted from the motor MG to the input shaft 36. The motor MG is connected to the battery 46 via the inverter 40 and the boost converter (not shown), for example, such that electric power is supplied and received between the motor MG and the battery 46. When the motor MG is used as the driving power source for running the vehicle, the clutch K0 is released, and the power of the motor MG is transmitted to the pair of drive wheels 34, via the torque converter 16, automatic transmission 18, propeller shaft 26, differential gear device 28, and the pair of axles 30.

The oil pump 22 is a mechanical oil pump coupled to the pump impeller 16a. The oil pump 22 is rotated or driven by the engine 14 (or motor MG) so as to generate a hydraulic pressure for controlling shifting of the automatic transmission 18, controlling the torque capacity of the lock-up clutch 38, controlling engagement/release of the clutch K0, and supplying lubricating oil to respective portions of the power transmission path of the vehicle 10. The drive-train 12 further includes an electric oil pump 52 that is driven by an electric motor (not shown). When the oil pump 22 is not driven, such as when the vehicle is stopped, the electric oil pump 52 is operated as a secondary pump to generate a hydraulic pressure.

The clutch K0 is a wet multiple disc type hydraulic friction device having a plurality of friction plates that are superimposed on each other and pressed by a hydraulic actuator. The engagement/release of the clutch K0 is controlled by a hydraulic control circuit 50 that is provided in the drive-train 12 and uses the hydraulic pressure generated by the oil pump 22 or electric oil pump 52 as an original pressure. In the engagement/release control, the torque capacity with which the clutch K0 can transmit power, namely, the engaging force of the clutch K0, is continuously changed, for example, through pressure regulation using a linear solenoid valve(s), or the like, in the hydraulic control circuit 50. The clutch K0 includes a pair of clutch rotary members, i.e., a clutch hub and a clutch drum, which are rotatable relative to each other when the clutch K0 is in the released state. The clutch hub as one of the clutch rotary members is coupled to the engine coupling shaft 32 such that the clutch hub and the shaft 32 cannot rotate relative to each other, and the clutch drum as the other clutch rotary member is coupled to the pump impeller 16a of the torque converter 16 such that the clutch drum and the pump impeller 16a cannot rotate relative to each other. With this arrangement, the clutch K0, when it is in the engaged state, permits the pump impeller 16a to rotate integrally with the engine 14 via the engine coupling shaft 32. Namely, when the clutch K0 is in the engaged state, the pump impeller 16a receives the driving force from the engine 14. On the other hand, when the clutch K0 is in the released state, power transmission between the pump impeller 16a and the engine 14 is cut off. Also, since the motor MG is operatively coupled to the pump impeller 16a, as described above, the clutch K0 functions as a clutch for connecting or disconnecting a power transmission path between the engine 14 and the motor MG. As the clutch K0 of this embodiment, a so-called normally open type clutch is used in which the torque capacity (engaging force) increases in proportion to the hydraulic pressure, and is placed in the released state in a condition where no hydraulic pressure is supplied thereto.

The automatic transmission 18 is connected to the motor MG without having the clutch K0 interposed therebetween, such that power can be transmitted between the automatic transmission 18 and the motor MG. The automatic transmission 18 provides a part of the power transmission path from the engine 14 and the motor MG to the drive wheels, and transmits power from the driving power sources (i.e., the engine 14 and the motor MG) toward the drive wheels 34. The automatic transmission 18 is a planetary gear type multi-speed transmission that functions as a stepwise variable automatic transmission that is shifted up or down through engagement of a selected one or ones of hydraulic friction devices, such as clutches C and brakes B, and release of another selected one or ones of the friction devices, so that a plurality of speeds (gear positions) are selectively established. Namely, the automatic transmission 18 is a stepwise variable transmission that performs so-called clutch-to-clutch shifting often used in known vehicles, and changes the speed of rotation of the transmission input shaft 36 and delivers the resulting rotation from the output shaft 24. The transmission input shaft 36 also serves as a turbine shaft that is rotated or driven by the turbine wheel 16b of the torque converter 16. Through control of engagement/release of the clutches C and brakes B, the automatic transmission 18 is placed in a given gear position (speed) selected according to the accelerating operation by the driver, vehicle speed V, etc. When all of the clutches C and brakes B are released, the automatic transmission 18 is placed in a neutral state, and the power transmission path between the drive wheels 34, and the engine 14 and motor MG, is cut off. The automatic transmission 18 corresponds to the transmission of the invention.

Referring again to FIG. 1, the vehicle 10 is provided with an electronic control device 100 including a control device associated with hybrid drive control, for example. The electronic control device 100 includes a so-called microcomputer including CPU, RAM, ROM, input and output interfaces, and so forth, and the CPU performs signal processing according to programs stored in advance in the ROM, utilizing the temporary storage function of the RAM, so as to execute various controls of the vehicle 10. For example, the electronic control device 100 performs output control of the engine 14, drive control of the motor MG including regeneration control of the motor MG, shift control of the automatic transmission 18, torque capacity control of the lock-up clutch 38, torque capacity control of the clutch K0, and so forth, and is configured to be divided as needed into a subunit for engine control, a subunit for motor control, a subunit for hydraulic control (or shift control), etc.

The electronic control device 100 is supplied with, for example, a signal indicative of the engine speed Ne as the rotational speed of the engine 14 detected by an engine speed sensor 56, a signal indicative of a turbine speed Nt of the torque converter 16 as an input rotational speed of the automatic transmission 18 detected by a turbine speed sensor 58, namely, a transmission input rotational speed Nin as the rotational speed of the transmission input shaft 36, a signal indicative of a transmission output rotational speed Nout as the rotational speed of the output shaft 24 detected by an output shaft speed sensor 60 and corresponding to the vehicle speed V or the rotational speed of the propeller shaft 26, as a value associated with the vehicle speed, a signal indicative of a motor speed Nmg as the rotational speed of the motor MG detected by a motor speed sensor 62, a signal indicative of the throttle opening θth as a degree of opening of an electronic throttle valve (not shown) detected by a throttle sensor 64, a signal indicative of the intake air amount Qair of the engine 14 detected by an intake air amount sensor 66, a signal indicative of the longitudinal acceleration G (or longitudinal deceleration G) of the vehicle 10 detected by an acceleration sensor 68, a signal indicative of the coolant temperature THw of the engine 14 detected by a coolant temperature sensor 70, a signal indicative of the oil temperature THoil of hydraulic oil in the hydraulic control circuit 50, which is detected by an oil temperature sensor 72, a signal indicative of the accelerator operation amount Acc as an operation amount of an accelerator pedal 76 detected by an accelerator position sensor 74, as the required amount of driving force (driver-requested power) that is requested by the driver to be applied to the vehicle 10, a signal indicative of the brake operation amount Brk as an operation amount of a brake pedal 80 detected by a foot brake sensor 78, as the required amount of braking force (driver-requested deceleration) that is requested by the driver to be applied to the vehicle 10, a signal indicative of a lever position Psh of a shift lever 84 selected from known “P”, “N”, “D”, “R” and “S” positions, for example, which lever position is detected by a shift position sensor 82, an amount of charge (charging capacity, charge remaining amount) SOC of the battery 46 detected by a battery sensor 86. The lever position may be referred to as “shift operation position”, “shift position”, or “operating position”. The electronic control device 100 is also supplied with electric power from an auxiliary battery 88. The auxiliary battery 88 is charged with electric power supplied from the battery 46 with its voltage stepped down by a DC/DC converter (not shown).

The electronic control device 100 outputs an engine output control command signal Se for output control of the engine 14, a motor control command signal Sm for controlling the operation of the motor MG, and hydraulic command signals Sp for operating or actuating electromagnetic valves (solenoid valves) included in the hydraulic control circuit 50 for control of the clutch K0 and the clutches C and brakes B of the automatic transmission 18, and the electric oil pump 52, for example.

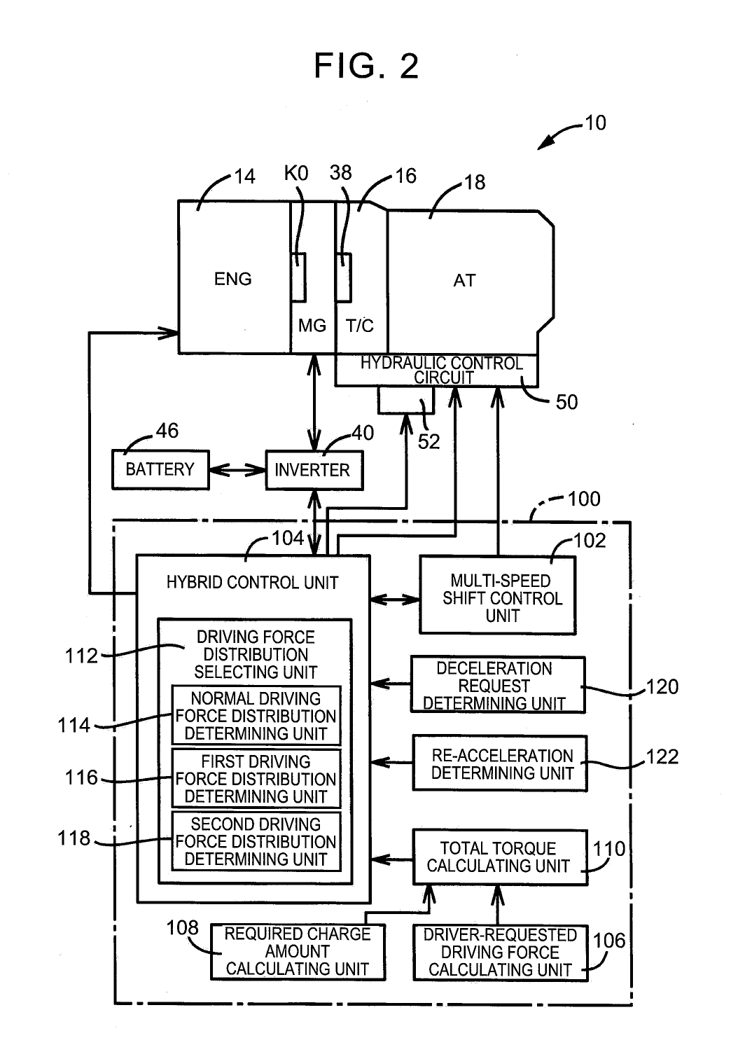

FIG. 2 is a functional block diagram useful for explaining principal control functions performed by the electronic control device 100. In FIG. 2, a multi-speed shift control means, or multi-speed shift control unit 102, functions as a shift control unit that shifts up or down the automatic transmission 18. The multi-speed shift control unit 102 determines whether the automatic transmission 18 should be shifted up or down, namely, determines a gear position (or speed) to which the automatic transmission 18 should be shifted, based on vehicle conditions indicated by the actual vehicle speed V and the accelerator operation amount Acc, from a known relationship (shift diagram, shift map), and performs automatic shift control of the automatic transmission 18 so as to establish the gear position (or speed) thus determined. The known relationship (shift diagram, shift map) having upshift lines and downshift lines is stored in advance, using the vehicle speed V and the accelerator operation amount Acc (or transmission output torque Tout, for example) as variables. For example, when the accelerator operation amount Acc (vehicle required torque) increases as the accelerator pedal 76 is depressed by an increased degree, and goes beyond one of the downshift lines toward a larger accelerator operation amount (larger vehicle required torque), the multi-speed shift control unit 102 determines that a request for downshift of the automatic transmission 18 has been made, and downshift control of the automatic transmission 18 corresponding to the downshift line is performed. At this time, the multi-speed shift control unit 102 outputs a command (shift output command, hydraulic command) SP to engage and/or release the coupling device(s) associated with shifting of the automatic transmission 18, to the hydraulic control circuit 50, so as to establish the gear position according to a predetermined engaging operation table stored in advance, for example. In order to release a coupling device (clutch) to be released and engage a coupling device (clutch) to be engaged, for example, thereby to perform shifting of the automatic transmission 18, the hydraulic control circuit 50 actuates linear solenoid valves in the hydraulic control circuit 50 according to the command Sp so as to operate hydraulic actuators of the coupling devices associated with the shifting.

The hybrid control means, or hybrid control unit 104, functions as an engine drive control unit that controls driving of the engine 14, and also functions as a motor operation control unit that controls the operation of the motor MG as a driving power source or generator via the inverter 40. With these control functions, the hybrid control unit 104 performs hybrid drive control, etc. using the engine 14 and the motor MG. For example, the hybrid control unit 104 functionally includes a driver-requested driving force calculating unit 106 that calculates the driving force requested by the driver, from the accelerator operation amount Acc and the vehicle speed V, a required charge amount calculating unit 108 that calculates the required charge amount from the charge amount SOC (charging capacity, charge remaining amount) of the battery 46, and a total torque calculating unit 110. The total torque calculating unit 110 calculates the total torque (total driving force) Ttotal to be generated by the engine 14 and the motor MG, based on the driver-requested driving force calculated by the driver-requested driving force calculating unit 106, and the required charge amount calculated by the required charge amount calculating unit 108. Once the total torque Ttotal is calculated by the total torque calculating unit 110, the hybrid control unit 104 executes distribution of the driving force (torque), by determining proportions of the driving forces of the engine 14 and the motor MG, which cooperate with each other to generate the total torque Ttotal, based on a driving force distribution selecting unit 112 which will be described later.

The driving force distribution selecting unit 112 includes a normal driving force distribution determining unit 114 selected during normal running of the vehicle. The normal driving force distribution determining unit 114 includes a driving force distribution map that is stored in advance, and specifies the driving force distribution of engine torque Te (engine driving force) and motor torque Tmg (motor driving force), based on the engine speed Ne and the total torque Ttotal, for example. The normal driving force distribution determining unit 114 determines the driving force distribution between the engine 14 and the motor MG, namely, the engine torque Te and the motor torque Tmg that provide the total torque Ttotal, by referring to the actual engine speed Ne and total torque Ttotal. The hybrid control unit 104 outputs output commands of the engine torque Te and motor torque Tmg thus determined, to the engine 14 and the motor MG (or the inverter 40 that controls the motor MG), respectively. In this connection, a plurality of driving force distribution maps are set based on the charging capacity SOC, for example.

More specifically, the driving force distribution map is set so that the proportion of the driving force of the engine 14 (the engine torque Te) is equal to zero, and the proportion of the driving force of the motor MG (the motor torque Tmg) is equal to 100, when the total torque Ttotal can be covered only by the motor torque Tmg of the motor MG. In this case, the running mode of the vehicle is set to the motor running mode (which will be called “EV running mode”). On the other hand, when the vehicle required torque cannot be covered without using at least the engine torque Te of the engine 14, the driving force distribution map is specified so that the vehicle runs using the engine torque Te and the motor torque Trng. For example, the driving force distribution of the engine torque Te and the motor torque Tmg is set so that the engine 14 is operated on the optimum fuel economy curve.

When the vehicle runs in the EV running mode, the hybrid control unit 104 releases the clutch K0 so as to cut off the power transmission path between the engine 14 and the torque converter 16, and causes the motor MG to generate the motor torque Tmg required to run the vehicle in the EV running mode. When the vehicle runs in the engine running mode, on the other hand, the hybrid control unit 104 engages the clutch K0 so that the driving force is transmitted from the engine 14 to the pump impeller 16a, and causes the motor MG to generate the motor torque Tmg determined based on the driving force distribution map.

When the accelerator pedal 76 is depressed by a larger amount while the vehicle is running in the EV running mode, for example, and the motor torque Tmg required to run the vehicle in the EV running mode, which corresponds to the vehicle required torque, exceeds a given torque range within which the vehicle can run in the EV running mode, the hybrid control unit 104 switches the running mode from the EV running mode to the engine running mode, and starts the engine 14 so as to run the vehicle in the engine running mode. Upon starting of the engine 14, the hybrid control unit 104 rotates or drives the engine 14 by transmitting engine starting torque Tmg for starting the engine from the motor MG via the clutch K0, while engaging the clutch K0 toward a fully engaged state, and starts the engine 14 by controlling engine ignition and fuel supply, for example, while raising the engine speed Ne to a given rotational speed or higher. After starting of the engine 14, the hybrid control unit 104 fully engages the clutch K0.

The hybrid control unit 104 also functions as a regenerative control means. During deceleration (or coasting) of the vehicle with the accelerator pedal being released, or during braking with the brake pedal 80 being depressed, the hybrid control unit 104 rotates or drives the motor MG using kinetic energy of the vehicle 10, namely, reverse driving force transmitted from the drive wheels 34 toward the engine 14, and operates the motor MG as a generator, so as to improve the fuel economy. Then, the hybrid control unit 104 charges electric energy generated by the motor MG into the battery 46 via the inverter 40. In the regenerative control, the amount of energy regenerated is determined based on the amount of charge SOC of the battery 46, distribution of braking forces produced by hydraulic brakes so as to provide braking force corresponding to the brake pedal operation amount, and so forth.

In the meantime, while the required driving force of the vehicle is reduced during deceleration of the vehicle, a request for re-acceleration is predicted when the vehicle is decelerated immediately ahead of a curve or ahead of an ETC tollgate, for example. Since the driver may feel uncomfortable if the response to re-acceleration is reduced, it is preferable to keep the response to re-acceleration at a high level. Also, the torque response of the engine 14 is generally poorer or worse than the torque response of the motor MG. In view of this fact, if the motor torque Tmg of the motor MG is reduced in advance during deceleration of the vehicle, an allowable amount of, increase of the motor torque Tmg during re-acceleration is increased, and the response to re-acceleration is improved. However, if the amount of reduction of the motor torque Tmg is increased, the amount of reduction of the engine torque Te is reduced as a tradeoff, whereby the engine torque Te is increased. Accordingly, the amount of fuel supplied to the engine 14 is increased, which may result in deterioration of the fuel economy.

Thus, when the hybrid control unit 104 reduces at least one of the engine torque Te and the motor torque Tmg when a request for deceleration is issued, it changes the proportion of reduction of the engine torque Te to that of the motor torque Tmg, according to a request for re-acceleration of the vehicle 10, so as to assure high response at the time of re-acceleration while improving the fuel economy. In the following, this control will be explained.

The driving force distribution selecting unit 112 further includes a first driving force distribution determining unit (which will be called “first determining unit”) 116 and a second driving force distribution determining unit (which will be called “second determining unit”) 118, which are selectively applied during deceleration of the vehicle, in addition to the normal driving force distribution determining unit 114. The first determining unit 116 is applied when a request for deceleration is issued based on release of the accelerator pedal, or the like, and is configured to make the amount of reduction of the motor torque Tmg larger than the amount of reduction of the engine torque Te when the total torque Ttotal (which will also be called “required driving force”) is reduced during deceleration of the vehicle. The first determining unit 116 includes a reduction proportion map that specifies the proportion of the amounts of reduction of the engine torque Te and the motor torque Tmg to the amount of reduction of the total torque Ttotal, so that the amount of reduction of the motor torque Tmg is larger than the amount of reduction of the engine torque Te. The amounts of reduction of the engine torque Te and the motor torque Tmg are determined based on this map. Although the reduction proportion specified in the reduction proportion map may change according to the amount of reduction of the total torque Ttotal, for example, the proportion of the amounts of reduction is set in either case so that the amount of reduction of the motor torque Tmg is larger than the amount of reduction of the engine torque Te.

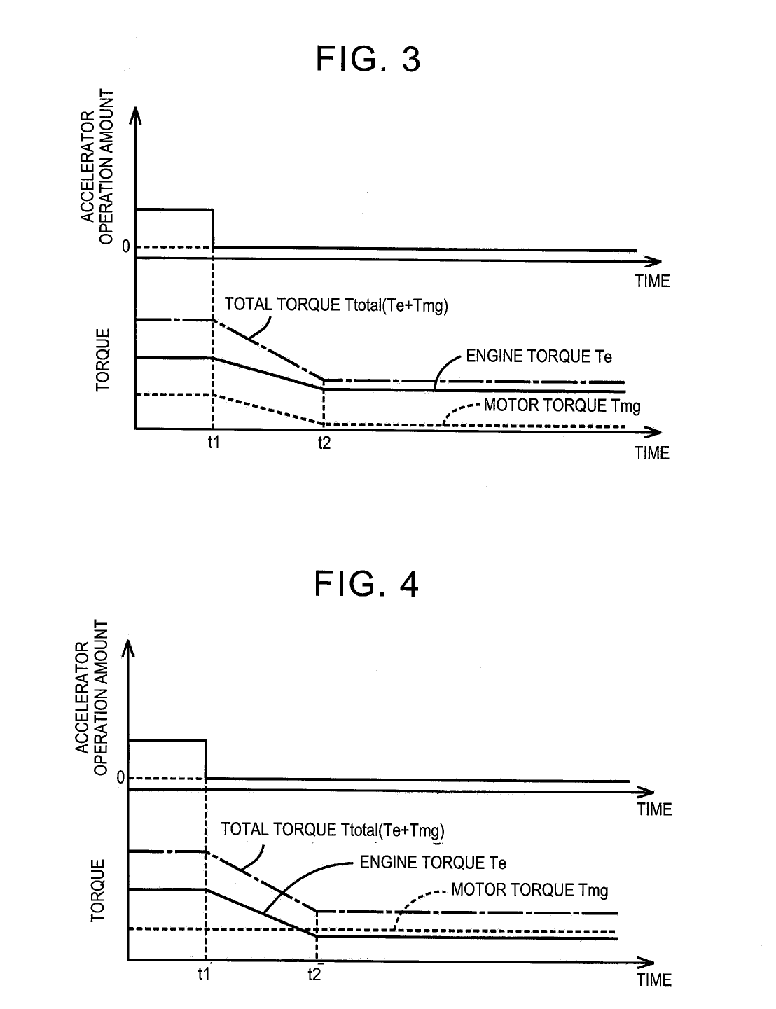

FIG. 3 shows changes in the engine torque Te and the motor torque Tmg when a request for deceleration is issued, which changes are effected by the first determining unit 116. If the accelerator pedal is released, and the accelerator operation amount Acc becomes equal to zero at time t1, it is determined that a request for deceleration has been issued, and the total torque Ttotal (=Te+Tmg) as indicated by a one-dot chain line in FIG. 3 is gradually reduced. As the total torque Ttotal gradually decreases, the engine torque Te and the motor torque Tmg are similarly gradually reduced. Here, the first determining unit 116 sets the distribution of the driving force so that the amount of reduction of the motor torque Tmg is larger than the amount of reduction of the engine torque Te. Therefore, while the engine torque Te as indicated by a solid line in FIG. 3 is reduced, the motor torque Tmg as indicated by a broken line is reduced by a larger amount than the engine torque Te. Then, the motor torque Tmg is kept at a low value upon and after time t2. In other words, upon and after time 2, a larger allowable amount of increase of the motor torque Tmg than an allowable amount of increase of the engine torque Te is ensured.

The second determining unit 118, which is applied when a request for deceleration is issued, is configured to make the amount of reduction of the motor torque Tmg smaller than the amount of reduction of the engine torque Te when the total, torque Ttotal is reduced during deceleration of the vehicle. The second determining unit 118 includes a reduction proportion map that specifies the proportion of the amounts of reduction of the engine torque Te and the motor torque Tmg to the amount of reduction of the total torque Ttotal, so that the amount of reduction of the motor torque Tmg is smaller than the amount of reduction of the engine torque Te. The amounts of reduction of the engine torque Te and the motor torque Tmg are determined based on this map. Although the reduction proportion specified in the reduction proportion map may change according to the amount of reduction of the total torque Ttotal, for example, the proportion of the amounts of reduction is set in either case so that the amount of reduction of the motor torque Tmg is smaller than the amount of reduction of the engine torque Te.

FIG. 4 shows changes in the engine torque Te and the motor torque Tmg when a request for deceleration is issued, which changes are effected by the second determining unit 118. If the accelerator pedal is released, and the accelerator operation amount Acc becomes equal to zero at time t1, it is determined that a request for deceleration has been issued, and the total torque Ttotal (=Te+Tmg) as indicated by a one-dot chain line in FIG. 4 is gradually reduced. Since the second determining unit 118 sets the distribution of the driving force so that the amount of reduction of the motor torque Tmg is smaller than the amount of reduction of the engine torque Te, the engine torque Te as indicated by a solid line in FIG. 4 is reduced, while the motor torque Tmg as indicated by a broken line is kept constant. Then, the motor torque Tmg is kept at a higher value than the engine torque Te upon and after time t2. Thus, when the second determining unit 118 is applied, the engine torque Te is reduced, and the amount of fuel supplied to the engine is reduced, resulting in improvement of the fuel economy.

When a request for deceleration is issued, the driving force distribution selecting unit 112 determines switching between the first determining unit 116 and the second determining unit 118, based on whether the vehicle is in running conditions in which a request for re-acceleration is predicted. The request for deceleration is determined by a deceleration request determining unit 120. The deceleration request determining unit 120 determines whether a deceleration request is issued, based on an accelerator pedal releasing operation to release the accelerator pedal 76 that has been depressed. A re-acceleration determining unit 122 determines whether the vehicle is in running conditions in which a request for re-acceleration after deceleration is predicted. The re-acceleration is predicted during deceleration in the cases where the vehicle is running toward or approaching a curve, where the vehicle is running toward or approaching an ETC tollgate, where the vehicle is decelerated under cruise control, and where the vehicle is switched to the manual shift mode, for example. The re-acceleration determining unit 122 predicts a request for re-acceleration if the vehicle is in any of the above-described running conditions. Information relating to these running conditions can be obtained from road information, etc. available from a car navigation system, for example.

If a request for re-accelerating the vehicle that has been decelerated is predicted by the re-acceleration determining unit 122, the driving force distribution selecting unit 112 determines the amount of reduction of the engine torque Te and that of the motor torque Tmg during deceleration, based on the first determining unit 116. When a request for re-accelerating the vehicle that has been decelerated is predicted, the vehicle is desired to be quickly accelerated. In this case, if the driving force distribution is set by the first determining unit 116, the amount of reduction of the motor torque Tmg of the motor MG is increased. In other words, an allowable amount of increase of the motor torque Tmg when the vehicle is re-accelerated is increased. Accordingly, the vehicle can be re-accelerated with the motor torque Tmg of the motor MG having an excellent torque response. Namely, the response at the time of re-acceleration is ensured.

If no request for re-accelerating the vehicle that has been decelerated is predicted by the re-acceleration determining unit 122, the deceleration request determining unit 120 determines whether the vehicle keeps running while being decelerated. The vehicle keeps running while being decelerated, in the case where the vehicle is running toward or approaching a traffic light, where the brake pedal 80 is kept depressed, or where the vehicle is running on a steep downhill, for example. The deceleration request determining unit 120 predicts that the vehicle keeps running while being decelerated, when it determines that the vehicle is in any of the running conditions as described above. If it is determined that the vehicle keeps running while being decelerated, the driving force distribution selecting unit 112 determines the amounts of reduction of the engine torque Te and the motor torque Tmg during deceleration, based on the second determining unit 118. Accordingly, the amount of reduction of the engine torque Te becomes larger than the amount of reduction of the motor torque Tmg. Since the engine torque Te is reduced in this manner, the amount of fuel supplied to the engine 14 is reduced, and the fuel economy is improved. If the deceleration request determining unit 120 does not predict that the vehicle keeps running while being decelerated, the amount of reduction of the engine torque Te and that of the motor torque Tmg during deceleration are determined, based on the normal driving force distribution determining unit 114.

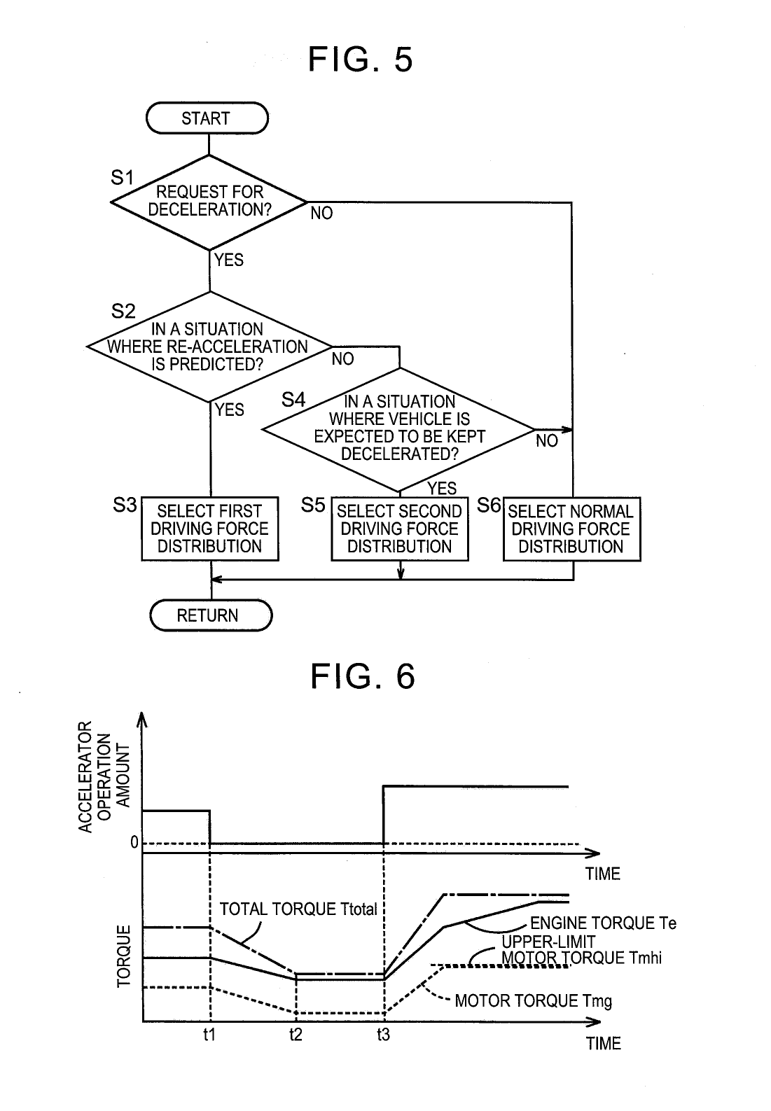

FIG. 5 is a flowchart useful for explaining principal control operations of the electronic control device 100, namely, control operations for assuring high response when the vehicle that has been decelerated is re-accelerated, while improving the fuel economy during deceleration of the vehicle. A control routine illustrated in FIG. 5 is repeatedly executed in very short cycles of about several milliseconds to several tens of milliseconds, for example.

Initially, in S1 corresponding to the deceleration request determining unit 120, it is determined whether a request for deceleration of the vehicle (request for reduction of the driving force) has been issued, based on an operation to release the accelerator pedal 76, for example. If a negative decision (NO) is made in S1, the engine torque Te and the motor torque Tmg are determined based on a conventional driving force distribution map set during normal running of the vehicle, in S6 corresponding to the normal driving force distribution determining unit 114. If an affirmative decision (YES) is made in S1, it is determined in S2 corresponding to the re-acceleration determining unit 122 whether the vehicle is in running conditions in which a request for re-acceleration is predicted during deceleration. If an affirmative decision (YES) is made in S2, it is determined that the request for re-accelerating the vehicle that has been decelerated is predicted. Then, in S3 corresponding to the first determining unit 116, the driving force is distributed so that the amount of reduction of the motor torque Tmg becomes larger than the amount of reduction of the engine torque Te. With the motor torque Tmg thus reduced, an allowable amount of increase of the motor torque Tmg is increased; therefore, the vehicle can be quickly re-accelerated with the motor torque Tmg.

If a negative decision (NO) is made in S2, it is determined in S4 corresponding to the deceleration request determining unit 120 whether the vehicle is expected to be kept decelerated. If a negative decision (NO) is made in S4, the engine torque Te and the motor torque Tmg are determined based on the conventional driving force distribution map in S6. If an affirmative decision (YES) is made in S4, the driving force is distributed in S5 corresponding to the second determining unit 118 so that the amount of reduction of the engine torque Te becomes larger than the amount of reduction of the motor torque Tmg. Accordingly, the engine torque Te is reduced, and the amount of fuel injected into the engine 14 is reduced, resulting in improvement of the fuel economy. Although the response to re-acceleration is reduced if the driving force distribution is determined based on the second determining unit 118, re-acceleration is less likely or unlikely to be requested, and therefore, the reduction of the response has a small influence.

FIG. 6 is a time chart indicating operating conditions when step S3 is executed in the flowchart of FIG. 5. In FIG. 6, if the accelerator pedal 76 is released and the accelerator operation amount Acc becomes equal to zero at time t1, it is determined that a request for deceleration has been issued, and the total torque Ttotal is gradually reduced as indicated by a one-dot chain line in FIG. 6. Similarly, the engine torque Te and the motor torque Tmg are gradually reduced in accordance with the reduction in the total torque Ttotal. In the time chart of FIG. 6, the engine torque Te and the motor torque Tmg are determined based on the first determining unit 116; therefore, the amount of reduction of the motor torque Tmg is larger than the amount of reduction of the engine torque Te. At time t2 at which the reduction of the total torque Ttotal is stopped, the motor torque Tmg is largely reduced. More specifically, the motor torque Tmg is reduced down to a low value relative to the upper-limit motor torque Tmhi that can be produced by the motor MG. Then, if the accelerator pedal 76 is depressed again and a request for re-acceleration is issued at time t3, the total torque Ttotal is increased, and the engine torque Te and the motor torque Tmg are increased in accordance with the increase of the total torque Ttotal. Since the motor torque Tmg is set to the low value at time t3, and is allowed to be increased to the upper-limit motor torque (Tmhi) by a large amount (Tmhi−Tmg), the vehicle can be quickly re-accelerated with the motor torque Tmg following the total torque Ttotal well. In this connection, the upper-limit motor torque Tmhi of the motor MG is determined as a rated torque for each motor.

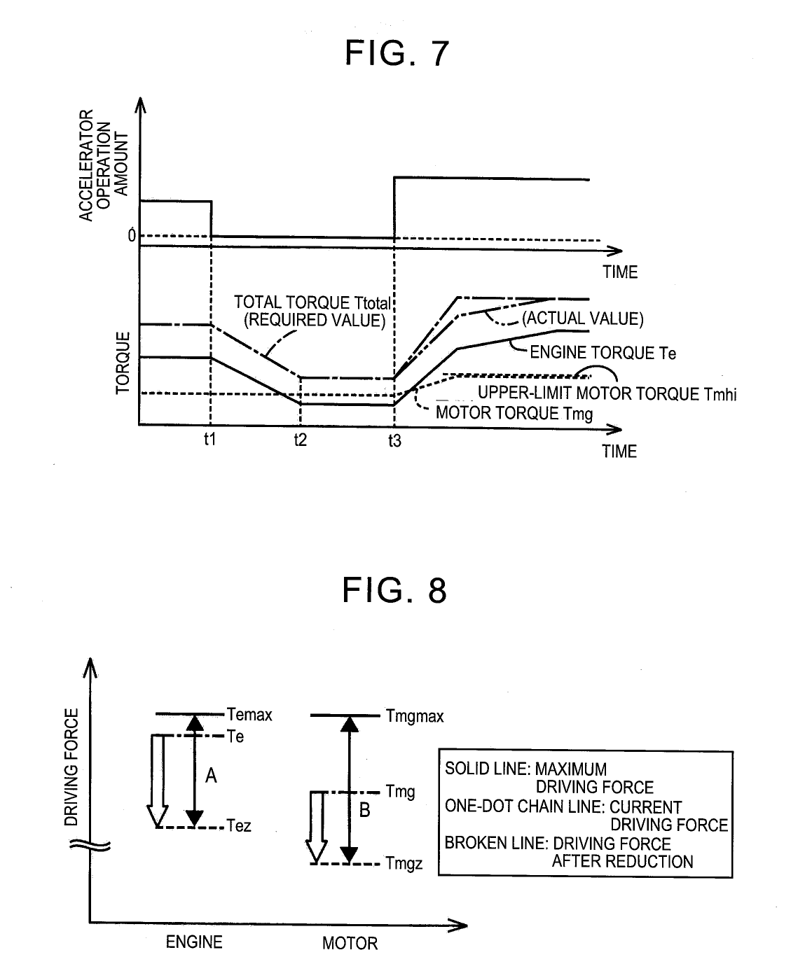

FIG. 7 is a time chart indicating operating conditions when step S5 is executed, in the time chart of FIG. 5. In FIG. 7, if the accelerator pedal 76 is released and the accelerator operation amount Acc becomes equal to zero at time t1, it is determined that a request for deceleration has been issued, and the total torque Ttotal is gradually reduced as indicated by a one-dot chain line in FIG. 7. Similarly, the engine torque Te is gradually reduced in accordance with the reduction in the total torque Ttotal. In the time chart of FIG. 7, the engine torque Te and the motor torque Tmg are determined based on the second determining unit 118; therefore, the amount of reduction of the engine torque Te is larger than the amount of reduction of the motor torque Tmg. On the other hand, the motor torque Tmg has not been changed from before the vehicle starts being decelerated. Namely, the total torque Ttotal is reduced only due to the reduction of the engine torque Te. At time t2 at which the reduction of the total torque Ttotal is stopped, the engine torque Te is reduced, and the amount of fuel supplied to the engine 14 is reduced, resulting in improvement of the fuel economy. If the accelerator pedal 76 is depressed again at time t3, and a request for re-acceleration is issued, the vehicle is re-accelerated substantially by use of the engine torque Te since an allowable amount of increase (Tmhi−Tmg) of the motor torque Tmg is small, and the torque response during re-acceleration is reduced. Accordingly, the actual value of total torque Ttotal indicated by a two-dot chain line in FIG. 7 is likely to deviate from the required value (target value) of total torque Ttotal indicated by the one-dot chain line (in FIG. 7). However, the possibility of re-acceleration is low when the engine torque Te and the motor torque Tmg are determined based on the second determining unit 118, and therefore, a problem is less likely or unlikely to occur due to the reduction of the response. Thus, the first determining unit 116 and the second determining unit 118 are selectively used depending on the presence or absence of a request for re-acceleration of the vehicle, so as to achieve improvements in both the fuel economy during deceleration and the response during re-acceleration.

When the total torque Ttotal is reduced during deceleration of the vehicle, the first determining unit 116 may determine the distribution of the driving force so that a difference ΔTe (=Temax−Tez) between the maximum value Temax of the engine torque Te (the maximum engine torque Temax) and the engine torque Tez reached after reduction of the driving force becomes smaller than a difference ΔTmg (=Tmgmax−Tmgz) between the maximum value Tmgmax of the motor torque Tmg (the maximum motor torque Tmgmax) and the motor torque Tmgz reached after reduction of the driving force.

FIG. 8 shows torque of the engine 14 and torque of the motor MG set by the first determining unit 116. In FIG. 8, solid lines indicate the maximum torques (Temax, Tmgmax: the maximum values of driving forces) set for the engine 14 and the motor MG, respectively, and one-dot chain lines indicate the current torques (Te, Tmg) of the engine 14 and the motor MG, respectively, while broken lines indicate torques (Tez, Tmgz) of the engine 14 and the motor MG, respectively, after reduction of the respective driving forces. Although the maximum engine torque Temax is equal to the maximum motor torque Tmgmax in FIG. 8, these values are not actually equal to each other since FIG. 8 merely indicates the magnitudes of differences in torques of the engine 14 and the motor MG, respectively. In FIG. 8, value A indicated by a two-headed arrow represents a difference ΔTe (=Temax−Tez) between the maximum value Temax of the engine torque Te and the engine torque Tez reached after reduction of the driving force. This value A is also referred to as an allowable amount of increase of the engine torque Te that can be generated during re-acceleration. Also, value B indicated by a two-headed mow represents a difference ΔTmg between the maximum value Tmgmax of the motor torque and the motor torque Tmgz reached after reduction of the driving force. This value B is also referred to as an allowable amount of increase of the motor torque Tmg that can be generated during re-acceleration.

As is understood from FIG. 8, the value B is larger than the value A. Namely, the allowable amount of increase of the motor torque Tmg that can be generated during re-acceleration is larger than the allowable amount of increase of the engine torque Te. Accordingly, if the first determining unit 116 is selected, the motor torque Tmg is allowed to be increased by a large amount, and the vehicle can be quickly re-accelerated by use of the motor torque Tmg. The first determining unit 116 has a map of difference values, which is set so that the difference ΔTmg of the motor torque Tmg is larger than the difference ΔTe of the engine torque Te, for example, and controls the engine torque Te and the motor torque Tmg so as to ensure the difference values. Accordingly, the difference ΔTmg of the motor torque Tmg becomes larger than the difference ΔTe of the engine torque Te. Thus, when the first determining unit 116 controls the driving force distribution of the engine torque Te and the motor torque Tmg, the allowable amount of increase of the motor torque Tmg is surely made larger than that of the engine torque Te; therefore, the response during re-acceleration can be improved by utilizing the motor torque Tmg of the motor MG having a good response. Accordingly, when a request for re-acceleration of the vehicle 10 is predicted, the first determining unit 116 is selected so as to provide the above-described effect.

As described above, according to this embodiment, re-acceleration of the vehicle 10 is determined in advance, and the proportion of reductions of the engine torque Te and the motor torque Tmg in response to a request for deceleration of the vehicle 10 is appropriately changed, so as to achieve improvements in both the fuel economy during deceleration, and the response when the vehicle that has been decelerated is re-accelerated.

Also, according to this embodiment, when re-acceleration of the vehicle 10 is requested while the vehicle 10 is being decelerated, the amount of reduction of the motor torque Tmg is larger than the amount of reduction of the engine torque Te; therefore, the vehicle 10 can be quickly re-accelerated by utilizing the motor torque Tmg of the motor MG having a better response than the engine 14. This is because the amount of reduction of the motor torque Tmg is made larger than that of the engine torque Te during deceleration of the vehicle, so that the motor torque Tmg is allowed to be increased by a large amount when the vehicle is re-accelerated. On the other hand, when no request for re-acceleration of the vehicle 10 is issued, the amount of reduction of the motor torque Tmg is smaller than the amount of reduction of the engine torque Te; therefore, the amount of fuel supplied to the engine 14 can be reduced, and the fuel economy can be improved. When no request for re-acceleration of the vehicle 10 is issued, there is no need to prepare for re-acceleration, and therefore, there is no need to reduce the motor torque Tmg in advance so as to ensure high response at the time of re-acceleration. Thus, the proportion of reductions of the engine torque Te and the motor torque Tmg is changed depending on the presence or absence of a request for re-acceleration of the vehicle, so that the fuel economy during deceleration and the response at the time of re-acceleration can be both improved.

Also, according to this embodiment, when a request for re-acceleration of the vehicle 10 is predicted, the difference ΔTmg between the maximum value Tmgmax of the motor torque Tmg and the motor torque Tmgz reached after reduction of the driving force is larger than the difference ΔTe between the maximum value Temax of the engine torque Te and the engine torque Tez reached after reduction of the driving force. Thus, when a request for re-acceleration of the vehicle 10 is predicted, an allowable amount of increase of the motor torque Tmg when the vehicle is re-accelerated is larger than an allowable amount of increase of the engine torque Te. Accordingly, the vehicle can be quickly re-accelerated by utilizing the motor torque Tmg of the motor MG having a good response at the time of re-acceleration.

Next, another embodiment of the invention will be described. In the following description, the same reference numerals as used in the above-described embodiment are assigned to components or portions shared by the above embodiment, and these components or portions will not be further described.

In the above-described embodiment, the amounts of reduction of the engine torque Te and the motor torque Tmg during deceleration of the vehicle are changed, based on whether a request for re-acceleration is predicted during deceleration. However, the amounts of reduction of the engine torque Te and the motor torque Tmg may be changed, based on whether the vehicle is in a situation where a request for downshift is predicted during deceleration. In the situation where downshift is requested, the vehicle is highly likely to be re-accelerated after downshifting. Accordingly, if it is determined that the vehicle is in a situation where downshift is requested, and the driving force distribution of the engine torque Te and the motor torque Tmg is appropriately set in advance, the vehicle can be quickly re-accelerated after downshifting. Here, situations where a request for downshift is predicted include, for example, the case where a manual shift mode is selected, the case where the vehicle is running on a winding road, and other cases. When downshift is actually requested in these situations, it is desirable to complete the downshift in a short period of time. The shift time of the downshift can be reduced by increasing torque applied to the transmission input shaft 36 of the automatic transmission 18 during shifting. If the engine torque Te and the motor torque Tmg are set based on the first determining unit 116 as described above, the torque applied to the transmission input shaft 36 is increased with improved response, and the shift time can be shortened. Thus, in this embodiment, the first determining unit 116 is selectively applied, based on whether the vehicle is in a situation where a request for downshift is predicted, so that the response at the time of re-acceleration and the fuel economy are improved.

The driving force distribution selecting unit 112 predicts a possibility of downshift, based on whether the manual shift mode is selected during deceleration, or whether the vehicle is running on a winding road, for example, and selects one of the first determining unit 116 and the normal driving force distribution determining unit 114, according to the result of prediction. For example, if it is determined that the manual shift mode is selected, or the vehicle is running on a winding road, it is determined that a request for downshift is predicted, and the amounts of reduction of the engine torque Te and the motor torque Tmg are determined, in other words, the driving force distribution is determined, based on the first determining unit 116. If it is determined that no request for downshift is predicted, the amounts of reduction of the engine torque Te and the motor torque Tmg (driving force distribution) are determined based on the normal driving force distribution determining unit 114.

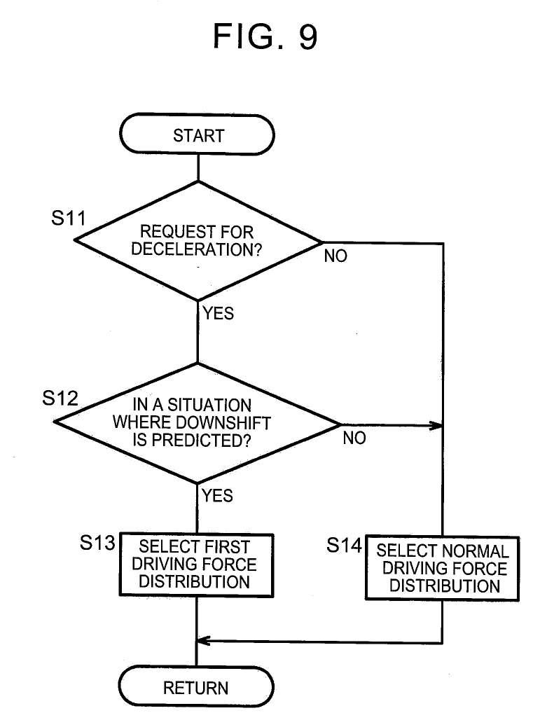

FIG. 9 is a flowchart useful for explaining principal control operations of the electronic control device 100 according to another embodiment of the invention, namely, control operations for assuring high response when the vehicle that has been decelerated is re-accelerated, while improving the fuel economy during deceleration of the vehicle.

Initially, it is determined in S11 corresponding to the deceleration request determining unit 120 whether a request for deceleration of the vehicle has been issued. If a negative decision (NO) is made in S11, the engine torque Te and the motor torque Tmg are determined based on the conventional driving force distribution map set under normal running conditions, in S14 corresponding to the normal driving force distribution determining unit 114. If an affirmative decision (YES) is made in S11, it is determined in S12 corresponding to the driving force distribution selecting unit 112 whether the vehicle is in a situation where downshift is requested. If a negative decision (NO) is made in S12, the engine torque Te and the motor torque Tmg are determined based on the conventional driving force distribution map in S14. If an affirmative decision (YES) is made in S12, the driving force distribution is determined in S13 corresponding to the first determining unit 116, so that the amount of reduction of the engine torque Te is made smaller than the amount of reduction of the motor torque Tmg. Accordingly, if downshift is requested, input torque applied to the transmission input shaft 36 of the automatic transmission 18 can be quickly increased, and the shift time can be shortened, resulting in improved response with which the vehicle is re-accelerated. If no request for downshift is predicted, the engine torque Te and the motor torque Tmg are determined based on the normal driving force distribution map, so that the fuel economy is improved.

As described above, according to this embodiment, if a request for downshift of the transmission is predicted, the amount of reduction of the motor torque Tmg is made larger than that of the engine torque Te. Accordingly, if downshift of the automatic transmission 18 is requested, the torque applied to the automatic transmission 18 can be quickly increased, and the shift time of the automatic transmission 18 can be shortened.

While some embodiments of the invention have been described in detail with reference to the drawings, the invention may be embodied in other forms.

In the illustrated embodiment, if no request for re-acceleration of the vehicle is predicted, it is determined whether the vehicle is expected to be kept decelerated, and the driving force distribution is determined based on the second determining unit 118 if the vehicle is expected to be kept decelerated, while the driving force distribution is determined based on the normal driving force distribution determining unit 114 if the vehicle is not expected to be kept decelerated. However, when no request for re-acceleration is predicted, the driving force distribution may be determined based on the normal driving force distribution determining unit 114 or the second determining unit 118, without determining whether the vehicle is expected to be kept decelerated. Namely, step S4 of FIG. 5 may be omitted.

While the first determining unit 116 and the second determining unit 118 are set in advance in the illustrated embodiments, only one of these determining units may be set and implemented.

While the normal driving force distribution determining unit 114 includes the driving force distribution map using the engine speed Ne and the total torque Ttotal as parameters, in the illustrated embodiments, the parameters of the driving force map are not limited to these, but may be changed as needed.

In the illustrated embodiments, the first determining unit 116 includes a map in which the amount of reduction of the motor torque Tmg is larger than the amount of reduction of the engine torque Te, during deceleration of the vehicle, and the second determining unit 118 includes a map in which the amount of reduction of the engine torque Te is larger than the amount of reduction of the motor torque Tmg, during deceleration of the vehicle. However, the driving force distribution is not necessarily determined by using maps. For example, the amounts of reduction of the engine torque Te and motor torque Tmg may be determined, based on calculation formulas or computational expressions that consist of two or more pre-set parameters, and satisfy the above conditions, for example.

In the illustrated embodiment, as one example of control of the engine torque Te and motor torque Tmg based on the second determining unit 118, only the engine torque Te is reduced, and the motor torque Tmg is not changed. However, the motor torque Tmg is not necessarily controlled not to be changed, but may also be reduced. Namely, the motor torque Tmg may be changed as needed provided that the amount of reduction of the engine torque Te is larger than the amount of reduction of the motor torque Tmg.

While the torque converter 16 is used as a fluid transmission device in the illustrated embodiments, the torque converter 16 may not be necessarily provided. Also, another fluid transmission device, such as a fluid coupling having no torque amplifying function, may be used, in place of the torque converter 16.

In the illustrated embodiments, the invention is applied to the hybrid vehicle 10 as a mere example. The invention may also be applied to any other type of hybrid vehicle, provided that the vehicle includes an engine and a motor as driving sources, and is capable of running with the required driving force of the vehicle divided into engine torque Te and motor torque Tmg.

In the illustrated embodiments, the stepwise variable automatic transmission 18 is provided in which a selected one of a plurality of gear positions (speeds) is established by engaging one or more of hydraulic friction devices, such as clutches C and brakes B, and releasing another one or more of the friction devices so as to effect shifting. However, the transmission is not limited to this type of transmission, but may be another type of transmission, such as a continuously variable transmission.

It is to be understood that the above-described embodiments are merely exemplary, and that the invention may be embodied with various changes, modifications, or improvements, based on the knowledge of those skilled in the art to which the invention pertains.

What is claimed is:

1. A control system for a hybrid vehicle, comprising:
an engine that is a driving source of the vehicle;
a motor that is a driving source of the vehicle;
a controller configured to distribute required driving force of the vehicle into engine driving force and motor driving force, the controller being configured to reduce at least one of the engine driving force and the motor driving force in response to a request for deceleration of the vehicle, such that a proportion of an amount of reduction of the engine driving force and an amount of reduction of the motor driving force is changed, according to a request for re-acceleration of the vehicle.

2. The control system according to claim 1, wherein:
the controller is configured to predict the request for re-acceleration;
the controller is configured to control such that the amount of reduction of the motor driving force is larger than the amount of reduction of the engine driving force when the controller predicts the request for re-acceleration; and
the controller is configured to control such that the amount of reduction of the motor driving force is smaller than the amount of reduction of the engine driving force when the controller does not predict the request for re-acceleration.

3. The control system according to claim 1, wherein
when the controller predicts the request for re-acceleration, the controller is configured to control such that a difference between a maximum value of the motor driving force and the motor driving force reached after reduction of the driving force is larger than a difference between a maximum value of the engine driving force and the engine driving force reached after reduction of the driving force.

4. The control system according to claim 2, further comprising
a transmission provided on a power transmission path between the engine and the motor, and drive wheels, wherein
the controller predicts the request for re-acceleration when the controller predicts the downshift of the transmission.

5. The control system according to claim 3, further comprising
a transmission provided on a power transmission path between the engine and the motor, and drive wheels, wherein
the controller predicts the request for re-acceleration when the controller predicts the downshift of the transmission.

6. A control method for a hybrid vehicle having an engine and a motor as driving sources, comprising:
distributing required driving force of the vehicle into engine driving force and motor driving force, so as to run the vehicle with the engine driving force and the motor driving force; and
reducing at least one of the engine driving force and the motor driving force in response to a request for deceleration of the vehicle, such that a proportion of an amount of reduction of the engine driving force and an amount of reduction of the motor driving force is changed, according to a request for re-acceleration of the vehicle.

7. The control method according to claim 6, wherein:
the amount of reduction of the motor driving force is larger than the amount of reduction of the engine driving force when the request for re-acceleration is predicted; and
the amount of reduction of the motor driving force is smaller than the amount of reduction of the engine driving force when the request for re-acceleration is not predicted.

8. The control method according to claim 6, wherein
when the request for re-acceleration is predicted, a difference between a maximum value of the motor driving force and the motor driving force reached after reduction of the driving force is larger than a difference between a maximum value of the engine driving force and the engine driving force reached after reduction of the driving force.

9. The control method according to claim 7, wherein
the request for re-acceleration is predicted when downshift of a transmission is predicted.

10. The control method according to claim 8, wherein
the request for re-acceleration is predicted when downshift of a transmission is predicted.
